(19) United States
(12) Patent Application Publication
(10) Pub. No.: US 2020/0398841 A1
(43) Pub. Date: Dec. 24, 2020

(54) STRADDLE TYPE VEHICLE

(71) Applicant: HONDA MOTOR CO., LTD., Tokyo (JP)

(72) Inventors: Hiroshi MAEDA, Wako-shi (JP); Yoshiyuki KUROBA, Wako-shi (JP); Masashi HAGIMOTO, Wako-shi (JP)

(21) Appl. No.: 17/012,185

(22) Filed: Sep. 4, 2020

Related U.S. Application Data
(63) Continuation of application No. PCT/JP2018/011412, filed on Mar. 22, 2018.

(51) Int. Cl. B60W 30/165; B62J 50/22; B60W 50/14; G06K 9/00

(52) U.S. Cl. CPC B60W 30/165; B62J 50/22; B62J 45/41; G06K 9/00791; B60W 50/14

(57) ABSTRACT

A straddle type vehicle having a following cruise function for performing following cruise to follow a preceding vehicle sensed, comprises: a display unit capable of displaying information of the preceding vehicle at a plurality of display positions aligned in a vehicle width direction of the straddle type vehicle; and a selecting unit configured to select, as a following target, a preceding vehicle from among the plurality of preceding vehicles, wherein, when a plurality of preceding vehicles are sensed, the display unit displays preceding vehicle information respectively for the plurality of preceding vehicles at the display positions corresponding to the preceding vehicles sensed, and a preceding vehicle is selected as the following target by the selection unit from the preceding vehicle information displayed by the display unit.

### CROSS-REFERENCE TO RELATED APPLICATION

This application is a continuation of International Patent Application No. PCT/JP2018/011412 filed on Mar. 22, 2018, the entire disclosures of which is incorporated herein by reference.

### TECHNICAL FIELD

The present invention relates to a straddle type vehicle provided with a forward-area sensing function.

### BACKGROUND ART

A four-wheeled vehicle has been proposed (Patent Literature 1), which has Adaptive Cruise (A Control CC) function (hereinafter, this function will be referred to as a preceding vehicle following function or simply a following function) that senses, by using a radar or the like, another vehicle driving in front of the ego-vehicle and causes the four-wheeled vehicle to drive, following the another vehicle.

### CITATION LIST

### Patent Literature

PTL1: Japanese Patent Laid-Open No. 2002-219970

### SUMMARY OF INVENTION

### Technical Problem

However, the conventional ACC technique is for four-wheeled vehicles and if the ACC function is applied to two-wheeled vehicles, problems unique to the two-wheeled vehicles would arise. For example, the two-wheeled vehicles are narrow in vehicle width, and therefore can drive with a greater degree of freedom in a vehicle width direction within a lane on which the two-wheeled vehicle is driving. Thus, there would be a case where the preceding vehicle to follow cannot be specified to one vehicle.

An object of the present invention is to provide a straddle type vehicle with a following function that is capable of dealing with a case where a plurality of preceding vehicles are sensed.

### Solution to Problem

According to one aspect of the present invention, provided is a straddle type vehicle (1) having a following cruise function for performing following cruise, comprising: a display unit capable of displaying information of the preceding vehicle at a plurality of display positions aligned in a vehicle width direction of the straddle type vehicle; and a selecting unit configured to select, as a following target, a preceding vehicle from among the plurality of preceding vehicles, wherein, when a plurality of preceding vehicles are sensed, the display unit displays preceding vehicle information respectively for the plurality of preceding vehicles at the display positions corresponding to the preceding vehicles sensed, and a preceding vehicle is selected as the following target by the selection unit from the preceding vehicle information displayed by the display unit.

### Advantageous Effects of Invention

According to the present invention, it is possible to provide a straddle type vehicle with a following function that is capable of dealing with a case where a plurality of preceding vehicles are sensed.

### BRIEF DESCRIPTION OF DRAWINGS

FIG. 1 is a view illustrating a side view of a right side of a straddle type vehicle according to one embodiment of the present invention, and a control block thereof.

FIG. 2 is a view illustrating one example of a situation to which the embodiment is applicable.

FIG. 3 is a view illustrating one example of a display section configured to display preceding vehicle information.

FIG. 4 is a flow diagram illustrating a control process when auto following cruise is started.

FIG. 5 is a flow diagram illustrating a following target selecting process.

FIG. 6 is a flow diagram illustrating one example of a following cruise control process.

FIG. 7 is a view illustrating another example of a display section configured to display preceding vehicle information.

### DESCRIPTION OF EMBODIMENTS

Referring to the drawings, a straddle type vehicle according to an embodiment of the present invention will be described below. In the description, a direction along a travelling direction of the straddle type vehicle is referred to as a front-back direction, a right-left direction in a state in which a driver is riding is referred to as a vehicle width direction (or a right-left direction), a right direction viewed from the driver is referred to as a right direction, and a left direction viewed from the driver is referred to as a left direction.

[Straddle Type Vehicle]

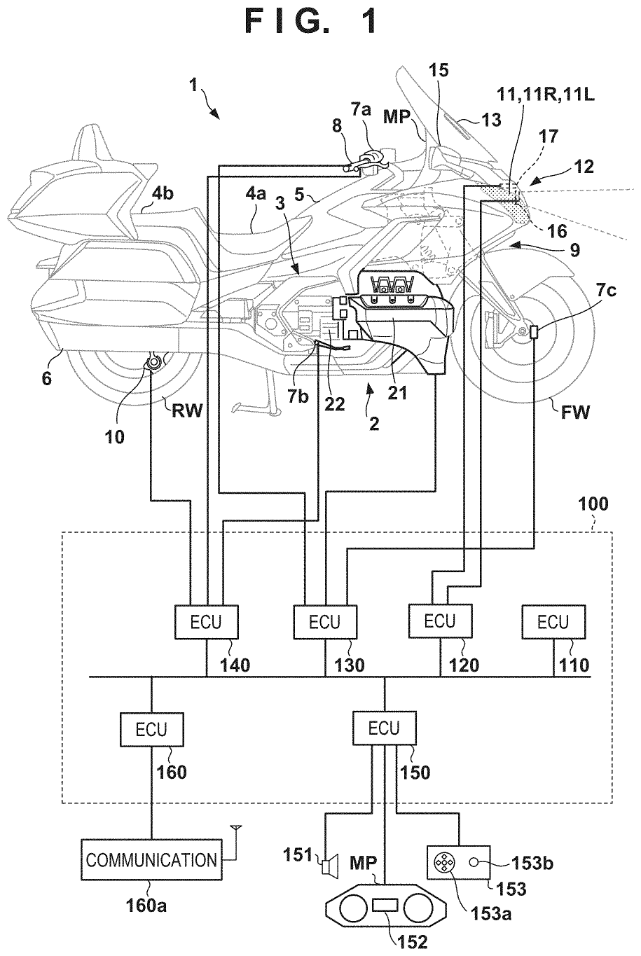

FIG. 1 is a view illustrating a right side of a straddle type vehicle 1 according to one embodiment of the present invention, and a configuration of an ECU (Electronic Control Unit) for controlling sections.

The straddle type vehicle 1 is a tourer-type motorcycle, which is suitable for a long-distance travel, but it should be noted that the present invention is also applicable to various straddle type vehicles including the other types of motorcycles, and is also applicable not only to vehicles whose driving sources are an internal combustion engine, but also to electric vehicles whose driving source is a motor. Hereinafter, the straddle type vehicle 1 may be referred to as a vehicle 1.

The vehicle 1 includes a power unit 2 between a front wheel FW and a rear wheel RW. The power unit 2 in the present embodiment includes a horizontally opposed-six engine 21 and a transmission 22. A driving force of the transmission 22 is transmitted to the rear wheel RW via a drive shaft (not shown), thereby rotating the rear wheel RW.

The power unit 2 is supported by a vehicle frame 3. The vehicle frame 3 includes a pair of main frames arranged to extend in an X direction and provided on the right and left sides respectively. On an upper portion of the main frames, a fuel tank 5 and an air cleaner box (not illustrated) are provided. In front of the fuel tank 5, a meter panel MP for displaying various information to a rider is provided.

In a front end portion of the main frames, ahead pipe is provided, which supports a steering shaft (not illustrated) so as to be rotatable configured to be rotated by a handlebar 8. In a rear end portion of the main frames, a pair of right and left pivot plates are provided. Lower end portions of the pivot plates are connected with the front end portion of the main frames via a pair of right and left lower arms (not illustrated), and the power unit 2 is supported by the main frame and the lower arms. In a rear end portion of the main frames, a pair of right and left seat rails extended backward is provided. The pair of seat rails supports a seat 4A for the rider to ride thereon, a seat 4b for a fellow passenger to ride together thereon, a rear trunk, and the like. A rear end portion of the seat rails and the pivot plates are connected via a pair of right and left sub frames.

The pivot plates are such that a front end portion of a rear swing arm (not illustrated) extending in the vehicle front-back direction is supported so as to be able to swing freely. The rear swing arm is capable of swinging in an up-and-down direction, and a rear end portion of the rear swing arm supports the rear wheel RW. On a lower portion on a side of the rear wheel RW, an exhaust muffler 6 for muffling sounds of exhaust of an engine 21 is provided to extend along the side of the rear wheel RW. On an upper portion on sides of the rear wheel RW, right and left saddle bags are provided.

On the front end portion of the main frames, a front suspension mechanism 9 for supporting the front wheel FW is configured. The front suspension mechanism 9 includes an upper link, a lower link, a fork supporter, a cushion unit, and a pair of right and left front forks.

[Front Portion Structure]

In a front portion of the vehicle 1, a headlight unit 11 for radiating light to a forward area with respect to the vehicle 1 is provided. The headlight unit 11 in the present embodiment is a twin-lens headlight unit including a right-side light radiating section 11R and a left-side light radiating section 11L positioned symmetrically on right and left positions. However, the headlight unit 11 may be a single-lens headlight unit or a triple-lens headlight unit, or a twin-lens headlight unit including light radiating sections positioned unsymmetrically on right and left positions.

The front portion of the vehicle 1 is covered with a front cover 12, and side portions of the front portion of the vehicle 1 are covered with a pair of right and left side covers, respectively. Above the front cover 12, a screen 13 is provided. The screen 13 is a windshield for alleviating wind pressure that the rider may receive in driving, and may be formed from a transparent resin member, for example. On sides with respect to the front cover 12, a pair of right and left side mirror units 15 is provided, respectively. The side mirror units 15 supports a side mirror (not illustrated) for use by the rider to see and check a backward area.

Behind the front cover 12, sensing units 16 and 17 configured to sense a state of a forward area in front of the vehicle 1 are arranged. In the case of the present embodiment, the sensing unit 16 is a radar (for example, a millimeter-wave radar), but may be another type of sensor that is capable of sensing the forward area through the front cover 12. For example, it may be configured such that, if the sensing unit 16 senses an obstacle in the forward area in front of the vehicle 1, a display to warm the rider will be displayed on the meter panel MP. The sensing unit 16 is provided in a center portion of the front cover 12 between the right and left headlight units.

In the case of the present embodiment, the sensing unit 16 is provided behind a cowl member. The presence of the cowl member can make the presence of the sensing unit 16 less noticeable when viewed from the front of the vehicle 1, thereby making it possible to avoid deterioration of an outer appearance of the vehicle 1. The cowl member is formed from a material that is transmissive with respect to electromagnetic waves, such as a resin.

The configuration in which the sensing unit 16 is positioned in the center portion of the front cover 12 makes it possible for the sensing unit 16 to have a sensing range wider in the right and left directions in the forward area of the vehicle 1, thereby facilitating the sensing of the state of the forward area of the vehicle 1 in such a way as to reduce failures to sense. Moreover, because the forward area of the vehicle 1 can be monitored with the one sensing unit 16 in such a way as to monitor the forward area symmetrically in the left and right direction. Thus, this configuration is especially advantageous in case where only one sensing unit 16 is provided instead of providing a plurality of sensing units 16.

Moreover, the sensing unit 17 is a camera configured to capture an image of the forward area. The sensing unit 17 may be referred to as a camera 17. The cowl member has an opening section in front of the camera 17, or is formed with a transparent member in front of the camera 17, so that the camera 17 can capture the image of the forward area via the opening or the transparent member.

Next, a control unit 100 will be described. The vehicle 1 includes the control unit 100, and the control unit 100 includes a plurality of ECUs 110 to 160 connected communicably to the control unit 100 via an in-vehicle network. Each of the ECUs includes a processor such as a CPU, typically, a storage device such as a semiconductor memory, an interface for communicating with an external device, and the like. The storage device stores programs that the processor executes, or data and the like that the processor uses in processing. Each of the ECUs may include a plurality of the processors, the storage devices, the interfaces, or the like.

In the following, functions and the like that the ECUs 110 to 160 individually have will be described. It should be noted that the vehicle 1 may be designed as appropriate regarding the number of the ECUs and the functions the ECUs individually have, and the functions may be more subdivided or further integrated to have more or less ECUs, compared with the present embodiment.

The ECU 110 is configured to perform control for autonomous driving of the vehicle 1, especially adaptive cruise control (referred to as ACC). The ACC of the present embodiment is configured to perform autonomous control of acceleration and deceleration of the vehicle 1. In a control example described later, the ECU 110 is configured to perform control of speed and acceleration and deceleration of the vehicle in order to follow, with a predetermined distance, a preceding vehicle that is sensed by the sensing unit 16 (radar 16) and/or sensing unit 17 (camera 17). The ECU 110 realizes the ACC by performing cooperative operation with another ECU for example with the ECU. Note that this example is so configured that if braking operation is manually performed, the ACC is cancelled and the vehicle 1 returns to non-ACC manual driving.

The ECU 120 is configured to perform control of the sensing units 16 and 17 for sensing a surrounding state of the vehicle 1, especially an object in the forward area, and to perform information processing of results of the sensing. The object sensed in the forward area is mainly a preceding vehicle, and therefore information of the preceding vehicle, especially information including a direction with respect to the vehicle 1 and a distance from the vehicle 1 is referred to as preceding vehicle information. The sensing units 16 and 17 for obtaining the preceding vehicle information and the ECU 120 for controlling the sensing units 16 and 17 may be referred to as a sensing section, a forward-area monitoring device, or a forward-area monitoring section, as a whole. The sensing unit 17 is a camera for capturing an image of the forward area of the vehicle 1, and in the case of the present embodiment, the sensing unit 17 is provided in the cowl member of the vehicle 1 and above the sensing unit 16. By analyzing the image captured by the camera 17, it is possible to perform extraction of a contour of the object, or the like operation. By analyzing a feature of the contour thus extracted, it is also possible to identify which type of vehicle the vehicle sensed. The type of vehicle includes, for example, whether the vehicle is a two-wheeled vehicle or a four-wheeled vehicle. Furthermore, among the four-wheeled vehicles, it is possible to distinguish whether the four-wheeled vehicle is a standard-sized vehicle or a large-sized vehicle by identifying a size of the four-wheeled vehicle from a distance sensed by the radar 16.

The sensing unit 16 may be a millimeter-wave radar, for example, and is configured to sense an object or objects in a surrounding area of the vehicle 1 and measure the direction and distance of the object from the vehicle 1. In the case of the present embodiment, one radar 16 is provided to face forward, but may be provided to face in another direction. Moreover, the radar 16 is capable of forwardly scanning a predetermined range in the vehicle width direction, thereby sensing an object in the range of the scanning. The range of scanning is substantially in a fan shape whose pivot is at the position where the radar 16 is positioned. The ECU 120 is configured to perform the control of the camera 17 and radar 16, and perform information processing of the sensing results.

The ECU 130 is configured to control the power unit 2. The power unit 2 is a mechanism for outputting a driving force for rotating the driving wheels of the vehicle 1, and may include the engine 21 and the transmission 22, for example. For example, the ECU 130 is configured to control the output of the engine 21 according to a driving operation (accelerator operation or acceleration operation) of the driver sensed by an operation sensing sensor 8a for an accelerator grip provided on the handlebar 8. In case where a driving state of the vehicle 1 is ACC (autonomous driving), the ECU 130 control the speed or acceleration and deceleration of the vehicle 1 by performing autonomous control of the power unit 2 according to an instruction from the ECU 110. Furthermore, ECU 130 may be configured such that, in an ACC mode, the ECU 130 switches over a gear range of the transmission 22 on the basis of information such as vehicle speed sensed by a vehicle speed sensor 7c.

The ECU 140 is configured to control brake devices 10. The brakes 10, which may be, for example, disc brake devices, are provided for the respective wheels of the vehicle 1, and are configured to decelerate or stop the vehicle 1 by applying resistance to wheel rotation. For example, the ECU 140 may be configured to control the operation of the brake device 10 according to a driving operation (brake operation) of the driver sensed by an operation sensing sensor 7b provided for a brake pedal. In case where the driving state of the vehicle 1 is ACC, the ECU 140 controls the deceleration and stopping of the vehicle 1 by performing autonomous control of the brake device 10 according to an instruction from the ECU 110. The brake device 10 may operate to maintain a stopping state of the vehicle 1.

The ECU 150 is configured to perform control of an input device 153 and output devices including a sound output device 151 and a display section 152. The input device 153 is configured to receive an input of information from the driver. In the example illustrated in FIG. 1, the input device 153 includes a selecting and determining key (which may be referred to as cross-shaped key or a directional pad) 152a and an ACC instructing button 153b among various input units. The sound output device 151 is a sound output device and is configured to notify the driver of information by sounds. Because it may be difficult to deliver sounds to the driver on the two-wheeled vehicle, a display device for displaying an image may be provided instead. The display section 152 is configured to notify the driver of information by displaying an image. The displaying section 152 is provided on the meter panel MP and, in this example, the displaying section 152 is especially used for determining and displaying a following target to follow in the ACC mode. Even though the display section is provided between meters in FIG. 1, the display section may be provided above the meters, for example. Note that the present embodiment exemplifies the sound and display, but the information may be notified by vibration or light. The input device 153 is a group of switches for instructing the vehicle 1, which are provided preferably at a position where the driver can manipulate the input device 153 while the driver is holding the handlebar. Among the group of switches, the selecting and determining key 153a may be, for example, a small-sized joy stick that can be pressed in upward, downward, rightward, and leftward directions by using a thumb of the right or left hand, and can be pushed down by further pressing. By instruction operation of navigation key portions for the upward, downward, rightward, and leftward directions, a change of selection can be instructed, and the selection can be determined by the pushing-down operation. By pushing down the button 153b, switching-on and switching-off of the ACC mode can be instructed. For example, if the button 153b is pressed down in the non-ACC mode (manual driving mode), the vehicle 1 shifts to the ACC mode, and if the button 153b is pressed down in the ACC mode, the vehicle 1 shifts to the non-ACC mode.

The ECU 160 is configured to control communication performed by a communication device 160a. This communication may include, for example, communication with a server device such as obtaining map information for a navigation device (not illustrated), or reception of signals from satellites via a GPS antenna. It should be noted that the control configuration illustrated in FIG. 1 is one example and control targets by one ECU may be further subdivided, or oppositely the control targets by one ECU may be further integrated. Moreover, the other sections such as a light may be controlled by autonomous control.

[Following Cruise on ACC Mode]

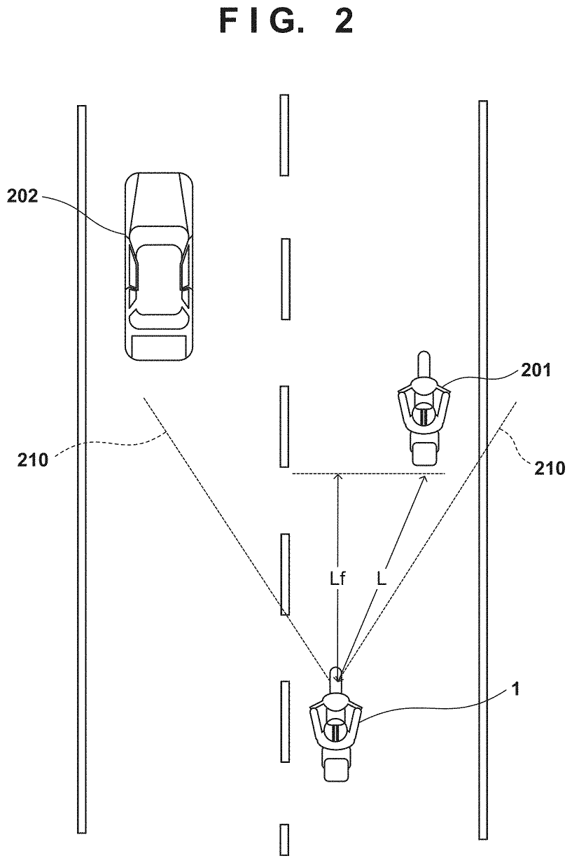

Next, the following cruise on ACC mode of the vehicle 1 will be described. FIG. 2 illustrates one example, viewed from above, of how the following cruise is performed. The vehicle 1 is a two-wheeled vehicle that can drive on ACC, and a vehicle 202 is a four-wheeled vehicle driving on a lane next to a lane on which the vehicle 1 is driving. A vehicle 201 is a two-wheeled vehicle driving on the same lane as the vehicle 1. The vehicle 1 is provided with the radar 16 for sensing an object in the forward area, and a scanning range 210 is a sensible range within which the radar 16 can sense. The radar 16 has a limitation in sensible distance within which the radar 16 can sense, but this limitation is not illustrated in FIG. 2, particularly.

In the state illustrated in FIG. 2, the vehicle 201 and the vehicle 202 are present within the scanning range of the radar 16, and therefore if the vehicle 1 is to perform the following cruise on the ACC mode, the vehicle 1 can select either one of the vehicle 201 and the vehicle 202 as a following target vehicle in this example. With respect to the vehicle set as the following target, the ECU 110 of the vehicle 1 maintains the speed of the vehicle 1 and controls the acceleration and deceleration as necessary in such a way that a distance to the following target vehicle is maintained at a constant distance, for example, a distance to the following target vehicle when the ACC is instructed is maintained. The distance maintained here may be a distance between the vehicles per se, but in this example, the distance maintained is a distance D in the travelling direction. Even if the direction to the following target vehicle is changed to some extent, the following the vehicle is continued as long as the extent of the change still allows the vehicle 1 to recognize the identity of the vehicle. However, if the following target vehicle goes out of the scanning range 210 or if the following target vehicle changes its position so suddenly that the vehicle 1 cannot recognize the identity of the vehicle, the following cruise is stopped. In this case, if losing the following target results in suddenly narrowing a throttle to rapidly decelerate, this would be dangerous especially on a highway. Thus, in order to avoid such sudden deceleration, it is desirable that the losing of the following target be notified to the driver and the speed be gradually slowed down or maintained as long as no approaching object is sensed near the vehicle 1 in the forward area.

[Following Cruise Control]

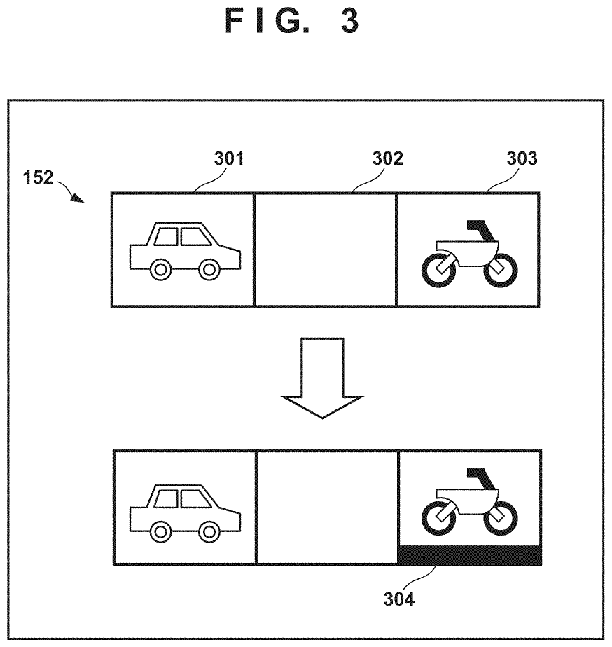

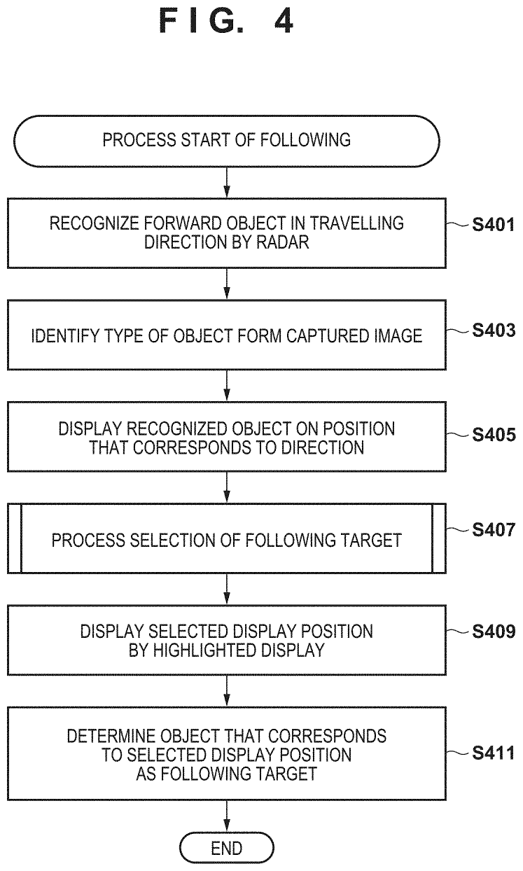

Referring to FIGS. 3 to 6, the control of the following cruise will be described. FIG. 4 is a flow chart illustrating a control procedure performed by the ECU 110 when triggered by pressing down the button 153b while the vehicle 1 is driving on the non-ACC mode (manual driving mode), for example.

In FIG. 4, to begin with, the scanning of the forward area by the radar 16 is started, and an object in the travelling direction, for example, a preceding vehicle is recognized according to reflected waves. Not only is the presence of the object recognized, but also a relative direction and distance from the vehicle 1 are specified (S401). It may be so configured that, if no object is sensed, step S401 is repeated until an object is sensed. In this example, it is assumed that the process is controlled as such. If there is a plurality of objects within the scanning range, the direction and distance are specified for each of the plurality of objects. The sensing of the preceding vehicle by the radar 16 may be carried out constantly. In this case, autonomous control based on a predicted reaching time to reach where the preceding vehicle is may be carried out. If an object is sensed, a speed of the object is measured. If the speed is equal to or close to 0, the object may be considered as not a preceding vehicle, and excluded from candidates for the following target. The description below will be made based on the preceding vehicle among objects sensed thereby.

Next, from an image captured by the cameral 17, a type of the vehicle is identified by image recognition (S403). The image recognition may be performed by pattern matching or machine learning. For example, the type of vehicle thus specified is stored in association with the direction of the preceding vehicle thus sensed by the radar 16.

Next, the object (preceding vehicle) thus recognized by the radar 16 is displayed on a display frame (that is, a display position) on the display section 152 that corresponds to the direction (S405). In the present embodiment, only the direction of the preceding vehicle is reflected on the display, whereas the distance is not reflected thereon. If no preceding vehicle is sensed, nothing will be displayed. FIG. 3 illustrates such a display example. In the example illustrated in FIG. 3, the display section 152 has display frames 301 to 303, and displays, in each of the display frames, an icon (or a symbol) corresponding to the type of the preceding vehicle for the display frame. Regarding the directions, for example, a central angle of the scanning range may be divided into several sections, and which section the direction of the preceding vehicle thus sensed belongs is specified. The sections are associated with the display frames on the display section 152, respectively, and the display is carried out based on the sections. In this example, the center angle of the scanning range is substantially equally divided into three, and if a main part of the preceding vehicle thus sensed is within the section, the preceding vehicle is displayed in the section as a preceding vehicle. In the example illustrated in FIG. 2, a four-wheeled vehicle is sensed on the left side and a two-wheeled vehicle is sensed on the right side. Types of the four-wheeled vehicle and the two-wheeled vehicle are specified. Further, in the example illustrated in FIG. 3, icons corresponding to the types of the preceding vehicles thus specified is displayed in the respective display frames 301 and 303 to which the directions of the preceding vehicles correspond, respectively. In this example, no preceding vehicle is sensed in a right front section with respect to the vehicle 1, so that the display frame 302 is empty. It may be so configured that, if a plurality of preceding vehicles are included in one section of the scanning range of the radar, only a preceding vehicle in a closest distance to the vehicle 1 is regarded as the preceding vehicle belonging to the section, and information of this preceding vehicle is stored.

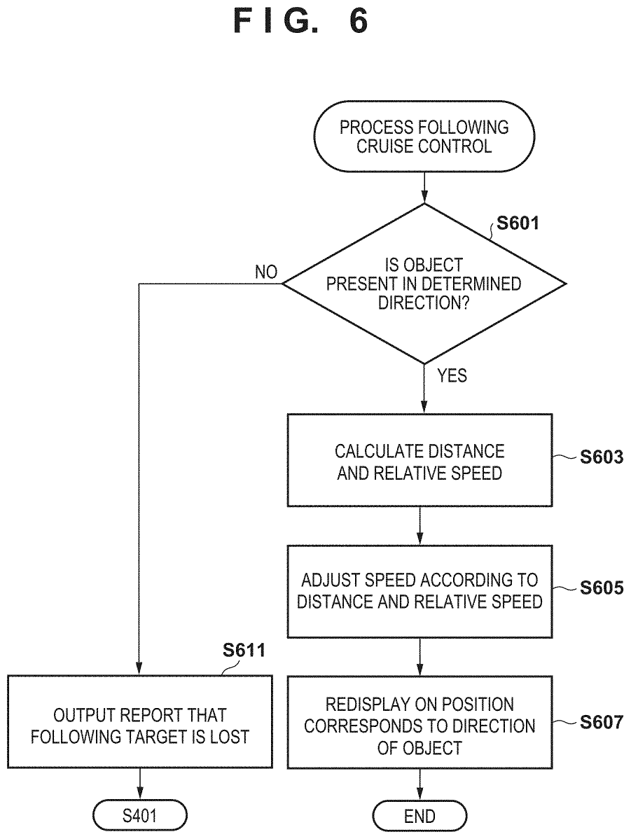

After that, a selection process for selecting a following target by the driver from among the preceding vehicles thus displayed (S407). When a following target is selected, the display position, on the display section 152, at which the target thus selected is positioned is displayed by highlighted display (S409). In the lower portion of FIG. 3, one example of such highlighted display is illustrated. In this example, the highlighted display is realized by displaying a strip-shaped portion 304 in a lower portion of the display frame, but of course, the present invention is not limited thereto. After that, the preceding vehicle thus selected is determined as the following target, and information of this preceding vehicle is stored as the following target (S411). The information of the preceding vehicle to be stored as the following target may include, for example, the direction, the distance, and the type of vehicle of the following target thus sensed. After the following target is determined, the control to follow the following target thus determined will be carried out by control illustrated in FIG. 6. Regarding the distance, a distance component in the travelling direction may be worked out as described below. The distance stored here is the distance to the following target to be maintained by the ACC control.

[Following Target Selecting Process]

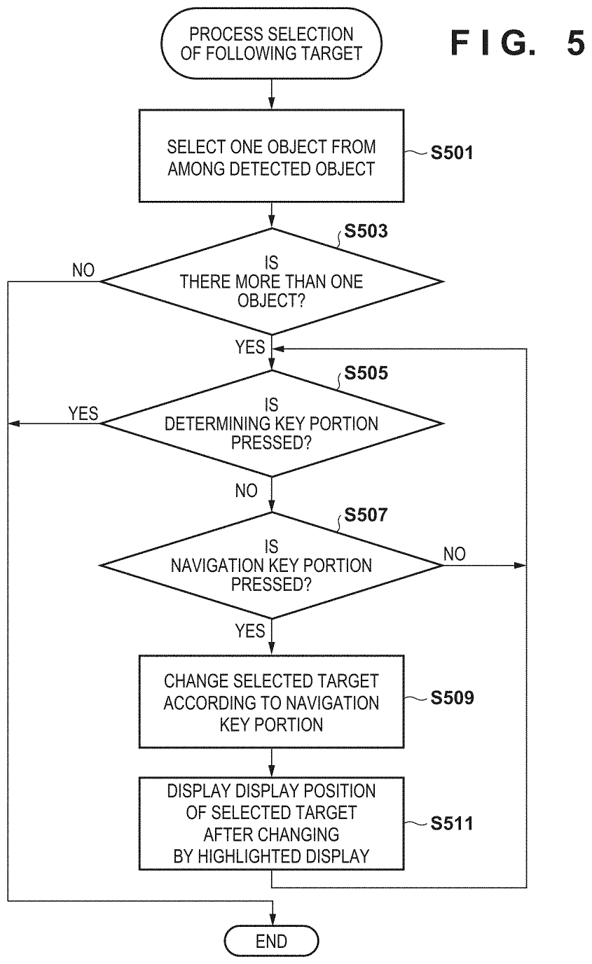

The following target determining process at step S407 will be described, referring to FIG. 5. To begin with, one object is selected from among the objects thus sensed (501). The selection may be carried out on any rule, and may be carried out by setting an order of priorities for the display frames, and selecting the target in the display frame with the highest priority (that is, the preceding vehicle in the section with the highest priority). Next, whether or not there is more than one object is determined (S503). If not, the process is ended. In this case, the only one preceding vehicle is automatically selected as the following target.

If it is determined that there is more than one preceding vehicle, a key input is waited, and whether or not a determining key portion of the selecting and determining key 153a has been pressed is determined (S505). If the determining key portion is pressed, the process is ended, and the target being selected at the time is determined as the target selected. If it is determined that the determining key has not been pressed, whether or not the key pressed is a navigation key portion of the selecting and determining key is determined (S507), and if the key pressed is not a navigation key, the process will return to step S505, and waits for a key operation of the driver. If a key operation other than these is made, a process corresponding to the key thus pressed may be carried out.

On the other hand, if it is determined that a navigation key portion is pressed, the selected target is changed according to the navigation key portion thus pressed (509). For example, if the rightward navigation key portion is pressed, the preceding vehicle in the section on the right-hand side with respect to the section currently selected will be reselected, and if the leftward navigation key portion is pressed, the preceding vehicle in the section on the left-hand side with respect to the section currently selected will be reselected. Note that the selection by the navigation key portion may be, instead of circulating, such that, if the far most section in one direction is reached, pressing the navigation key portion in the direction again will not change the selected target. This is for example because the driver of a two-wheeled vehicle would operate without looking at his/her hand. So, for example, if the driver pressed a navigation key portion in one direction many times, the driver can select the vehicle in the far most section in the direction. Moreover, if it is configured such that, for example, the upward navigation key portion is pressed in order to select the center section, it becomes possible to carry out the selection operation without looking at the hand.

After that, the display frame corresponding to the section thus selected is displayed by highlighted display (511). After that, pressing of a key is waited, and the process returns to step S505, and repeated until the determining key portion is pressed.

In this way, if there are a plurality of preceding vehicles sensed by the radar, the driver can select one from the plurality of preceding vehicles, and the preceding vehicle thus selected will be displayed on the display section 152 by highlighted display. Moreover, even though the example is configured such that the preceding vehicle thus determined as the following target as well as a preceding vehicle that is not determined but selected are displayed by highlighted display, the following target may be displayed by highlighted display other than that for the preceding vehicle that is not determined but selected. If the display section 152 is capable of performing color display, for example, the highlighted display may be carried out with another color. Moreover, instead of using the strip-shaped portion 304, the highlighted display may be such that the whole frame is highlighted.

FIG. 6 illustrates one example of the following control with respect to the following target thus determined as above. FIG. 6 is also carried out by ECU 110 or the like, for example. After the following target is determined by the process illustrated in FIG. 4, whether or not an object, that is, a preceding vehicle is present in the direction of the preceding target is determined (S601). Here, because the ego-vehicle as well as the following target are driving, the direction of the following target could possibly change. Thus, the recognition of the following target may be such that a preceding vehicle sensed in a predetermined range from a position at which the following target was last sensed is recognized as the following target. Because the position of the preceding vehicle is specified by the direction and the distance, the predetermined range may be a certain range from the last sensed position in terms of the direction and distance. At this time, the position (direction and distance) of the following target has been updated with the position of the following target thus recognized again. In case where the process is carried out continuously from step S411 of FIG. 4, it is considered that the preceding vehicle is sensed. However, the sensing may be lost due to the movement of the ego-vehicle and the following target vehicle during the following cruise. Step S601 is a step for such a case. If the following target is lost, a report that the following target is lost is outputted, for example, on the display section 152 or the like (S611). As described above, it may be configured such that, for the sake of avoiding danger, even if the following target is lost, the speed will not be slowed down immediately and will be maintained until the driver performs a deceleration operation or an accelerate operation.

If there is another preceding vehicle in a direction where the preceding vehicle thus determined as the following target, a distance and a relative speed with respect to the other preceding vehicle are calculated (S603). The relative speed may be calculated, for example, based on an interval between two scanning times and a difference of distances sensed by respective scanning operations performed at the scanning times. Moreover, if the radar is a radar capable of sensing the speed, the relative speed may be calculated by subtracting a speed sensed by a vehicle speed sensor 7c from the speed sensed by the radar. In this case, each of the speeds may possibly have their velocity vectors in different directions. So, if necessary, compensation for the difference in velocity vectors is carried out. For example, the compensation may be carried out in such a manner that, assuming that both of the vehicles are driving in the same direction, a component, of the speed thus sensed by the radar, in the direction in which the ego-vehicle is driving is taken as the relative speed. This applies to the case where the relative speed is calculated based on the distance and time. Again in this case, the difference is calculated by using the speed component in the direction in which the ego-vehicle is driving. Moreover, for the distance, a distance component in the travelling direction is obtained, so that the distance component is taken as the current distance. FIG. 2 illustrates relationship between a distance L between the vehicles and a distance Lf in the travelling direction. From the distance L sensed by the radar 16, the distance Lf, which is the component in the travelling direction, is obtained and taken as a vehicle-to-vehicle distance in the present embodiment. In this way, it is possible to perform the following cruise on the basis of the relative speed in the travelling direction, without being influenced by a speed difference or a distance in the vehicle width direction. Of course, the speed difference thus sensed or the distance L between the vehicles may be used as is.

After the distance and relative speed with respect to the following target are obtained as described above, the speed is controlled according to the distance and the relative speed thus obtained (S605). The control of the speed is carried out, for example, by controlling the power unit 2 via the ECU 130 or controlling the brake 10 via the ECU 140. What is aimed is to drive with a predetermined distance (the distance determined at S411) maintained. For example, if a current distance is longer than the targeted distance by a predetermined length or more and the relative speed is negative, the ego-vehicle is accelerated until the relative speed becomes positive. The relative speed after the acceleration may be about several Km/h, for example, but may be more or less depending on the difference between the current distance and the targeted distance. Such control is desirable that, if a current distance is longer than the targeted distance by a predetermined length or more and the relative speed is positive, deceleration of the ego-vehicle be started when the distance to the following target reaches a distance of “the targeted distance+the predetermined length,” and the deceleration is continued until the relative speed becomes zero, so that when the distance to the following target reaches the targeted distance, the relative speed will be zero. Moreover, for example, if the current distance is shorter than “targeted distance−a predetermined length” and the relative speed is positive, the ego-vehicle is decelerated until the relative speed becomes negative. The relative speed after the deceleration may be about—several Km/h, for example, but may be more or less depending on the difference between the current distance and the targeted distance. Such control is desirable that, if a current distance is shorter than the “targeted distance−the predetermined length” and the relative speed is negative, acceleration of the ego-vehicle be started when the distance to the following target reaches a distance of “the targeted distance−the predetermined length,” and the acceleration is continued until the relative speed becomes zero, so that when the distance to the following target reaches the targeted distance, the relative speed will be zero. Such control is carried out not in such a manner that the control is completed at step S605, but in such a manner that the control is gradually carried out by repeatedly carrying out the steps in FIG. 6. Moreover, the control may be such that, if the ego-vehicle is too close to the following target, that is, if the ego-vehicle gets too close to the following target beyond a predetermined braking start distance, not only controlling the accelerator but also braking via the ECU 140 is performed. Again in this case, it is desirable to avoid sudden braking and to release the braking when the distance reaches a predetermined safe distance.

After the speed adjustment is carried out, the positions of the preceding vehicles, including the following target, currently sensed by the radar 16 are specified as to which sections of the scanning range of the radar 16 the preceding vehicles are positioned, and the following target and the preceding vehicles are displayed in corresponding display frames accordingly (S607). In displaying them, for the following target, if the position of the following target is changed, not only the icon (image object) indicating the vehicle but also the highlighted display are moved to a display frame corresponding to the new position of the following target after the change.

By the controls described above, if there are a plurality of preceding vehicles sensed by the radar, it is possible for the driver to select one vehicle from among the plurality of preceding vehicles. After the preceding vehicle thus selected is determined as the following target, such driving control is performed that the distance from the ego-vehicle to the preceding vehicle is maintained to the distance that the ego-vehicle had between the ego-vehicle and the preceding vehicle when the ACC was instructed. Especially when selecting the following target, the preceding vehicles are displayed on the display section correspondingly to the directions of the preceding vehicles, so that the driver can select a preceding vehicle from the preceding vehicles thus displayed. With this configuration, in case where a plurality of preceding vehicles is sensed as candidates for the following target for a two-wheeled vehicle driving with a greater degree of freedom in the vehicle width direction, the driver can grasp this situation. Further, this configuration makes it possible to select the following target from the plurality of candidates. Further, this configuration makes it possible for the driver to grasp the types of vehicles from the display, making it easier for the driver to correspond with the current situation.

It should be noted that the camera 17 is not always essential, even though the present embodiment includes the camera 17 in order to specify which type of vehicle the preceding vehicle is. Without the camera 17, it would be difficult to specify the type of vehicle, but sensing a preceding vehicle can be carried out by the radar 16. So, by configuring such that the icon or symbol indicating the preceding vehicle is displayed instead of the icon indicating the type of vehicle, it is also possible to attain such a configuration that the plurality of the preceding vehicles is provided as candidates for the following target, and it is possible to select the following target from among the plurality of the preceding vehicles. Even though the present embodiment is such that braking is part of the control performed by the autonomous driving, the autonomous driving may be configured to control the accelerator but not the brake.

### Modification

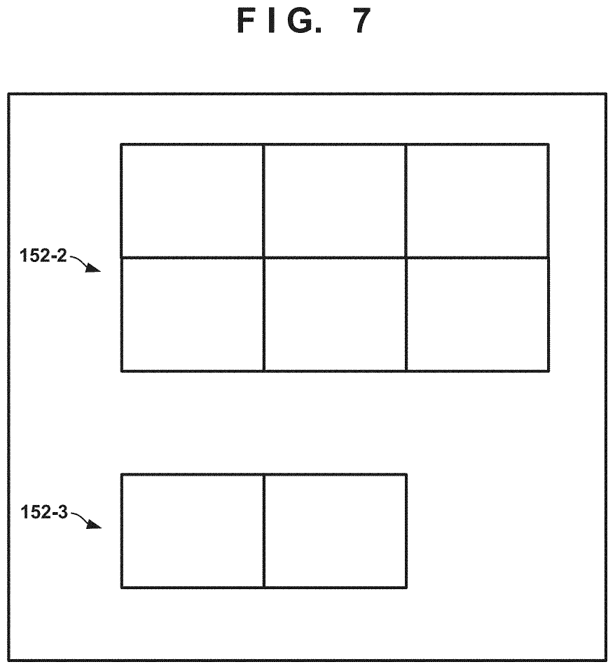

FIG. 7 illustrates another configuration of the display section 152. A display section 152-2 is an example in which more display frames are provided with three display frames in the vehicle width direction and two display frames in the vehicle front-back direction, thereby having six display frames in total. For example, the upper portions of the display frames correspond to the forward direction and the lower portions of the display frames correspond to the backward direction. The forward and backward are relative expression. For example, if the closest preceding vehicle is displayed in one display frame in the lower column, a preceding vehicle farther than the closest preceding vehicle is displayed in the upper column. Because there are three display frames aligned in the vehicle width direction, the central angle of the scanning range of the radar may be divided, for example into three, which are associated with the 3 columns of the display frames, respectively. This is the same as in the embodiment discussed above. It may be configured such that moving between the display frames in the vehicle front-back direction for when selecting the vehicle is carried out by using the navigation key portions corresponding to the forward and backward directions. In this way, actual positional relationship of the preceding vehicles can be reproduced on the display section, and the correspondence between the actual preceding vehicles and the following vehicle to be selected can be clearly and visually presented.

The display section 152-3 illustrated in FIG. 7 is another example of the display section. This example is further simplified than the display section of the embodiment above, and two display frames are aligned in the vehicle width direction. Thus, the display frames do not show the positional relationships of the preceding vehicles with respect to the ego-vehicle, but the relative positions of the preceding vehicles in the vehicle width direction. That is, of two preceding vehicles, the vehicle on the right side is displayed on the right display frame and the vehicle on the left side is displayed on the left display frame. If more than two vehicles are sensed, for example the closest vehicle and the second closest vehicle may be set as a target. In this case, either the right or left will be selected. Thus, the selecting of the following target may be carried out in a manner similar to that of the embodiment, but, as an alternative configuration, buttons respectively corresponding to the right and left display frames may be provided, so that the preceding vehicle displayed on the display frame corresponding to the button pressed is determined as the following target.

Moreover, even though in step S501 in FIG. 5, the display frame to be initially displayed by a highlighted display is set in advance, it may be configured such that the display frame set in advance can be changed by the user. Moreover, it may be configured such that the designation can be changed according to the days of week, time, current position detected by GPS or the like. Further, it may be configured such that relationship between the days of week, time, or position and the display frame selected according thereto may be trained by machine learning, and the display frame initially selected can be selected according to results of the learning.

The embodiment and modifications described above may be summarized as below.

(1) According to a first aspect of the invention of the present application, the present invention is a straddle type vehicle (1) having a following cruise function for performing following cruise to follow a preceding vehicle sensed, characterized by: display means (152) for displaying information of the preceding vehicle, the straddle type vehicle (1) being characterized in that, when a plurality of preceding vehicles are sensed, the display means displays preceding vehicle information respectively for the plurality of preceding vehicles. For two-wheeled vehicle with a high degree of freedom as to their driving positions in the vehicle width direction, this configuration makes it possible for the driver to recognize the state that there is a plurality of preceding vehicles detected as following targets.

(2) According to the second aspect of the invention of the present application, the straddle type vehicle according to (1), is characterized by further including: selecting means (153a) for selecting, as a following target, a preceding vehicle from among the plurality of preceding vehicles. This configuration makes it possible for the driver to select the following vehicle, thereby making it possible to perform the following cruise according to an intention of the driver.

(3) According to a third aspect of the invention of the present application, the straddle type vehicle according to (1) or (2), is characterized by further including: obtaining means (17) for obtaining information regarding types of the preceding vehicles, wherein ways of displaying preceding vehicle information are changed on the basis of information obtained by the obtaining means. This configuration facilitates improvement of distinguishability of information of the preceding vehicles (large-sized vehicle, medium sized-vehicle, small-sized vehicle, and the like) by reflecting information of the preceding vehicles on the display section.

(4) According to a fourth aspect of the invention of the present application, the straddle type vehicle according to any one of (1) to (3) is characterized in that the display means is capable of displaying preceding vehicle information at a plurality of display positions aligned in a vehicle width direction of the straddle type vehicle. This configuration makes it possible to easily recognize vehicle width direction-related information of the preceding vehicle to be the following target.

(5) According to a fifth aspect of the invention of the present application, the straddle type vehicle according to any one of (1) to (4) is characterized in that the display means is capable of displaying preceding vehicle information at a plurality of display positions aligned in a vehicle front-back direction of the straddle type vehicle. This configuration makes it possible to easily recognize vehicle front-back direction-related information of the preceding vehicle to be the following target.

(6) According to a sixth aspect of the invention of the present application, the straddle type vehicle according to (4) or (5) is characterized in that the display means displays preceding vehicle information at the display positions corresponding to positions of the preceding vehicles sensed. This configuration makes it possible to easily grasp the positional relationship of the preceding vehicle to be the following target.

(7) According to a seventh aspect of the invention of the present application, the straddle type vehicle according to any one of (1) to (6) is characterized by further comprising: sensing means (16, 17) for sensing preceding vehicles and providing information of the preceding vehicles. This configuration makes it possible to obtain the information of the following target by the sensing means.

The present invention is not limited to the above embodiments and various changes and modifications can be made within the spirit and scope of the present invention. Therefore, to apprise the public of the scope of the present invention, the following claims are made.

What is claimed is:

1. A straddle type vehicle (1) having a following cruise function for performing following cruise to follow a preceding vehicle sensed, comprising:
a display unit capable of displaying information of the preceding vehicle at a plurality of display positions aligned in a vehicle width direction of the straddle type vehicle; and
a selecting unit configured to select, as a following target, a preceding vehicle from among the plurality of preceding vehicles,
wherein, when a plurality of preceding vehicles are sensed, the display unit displays preceding vehicle information respectively for the plurality of preceding vehicles at the display positions corresponding to the preceding vehicles sensed, and
a preceding vehicle is selected as the following target by the selection unit from the preceding vehicle information displayed by the display unit.

2. The straddle type vehicle according to claim 1, further comprising:
an obtaining unit configured to obtain information regarding types of the preceding vehicles,
wherein an appearance of the displayed preceding vehicle information is changed on the basis of information obtained by the obtaining unit.

3. The straddle type vehicle according to claim 1, wherein the display unit is further capable of displaying the preceding vehicle information at a plurality of display positions aligned in a vehicle front-back direction of the straddle type vehicle.

4. The straddle type vehicle according to claim 1, further comprising a sensing unit configured to sense a preceding vehicle and providing information of the preceding vehicle.
